(19) United States
(12) Patent Application Publication
(10) Pub. No.: US 2005/0044484 A1
(43) Pub. Date: Feb. 24, 2005

(54) Updating information content onto small display

(75) Inventor: Mikko K. Makela, Tampere (FI)

Correspondence Address: Crawford Maunu PLLC, Suite 390, 1270 Northland Drive, St. Paul, MN, 55120, US

(73) Assignee: Nokia Corporation

(21) Appl. No.: 10/918,929

(22) Filed: Aug. 16, 2004

(30) Foreign Application Priority Data
Aug. 19, 2003 (FI) 20031169
Mar. 30, 2004 (FI) 20045112

(51) Int. Cl. G06F 17/21

(52) U.S. Cl. 715/501.1

(57) ABSTRACT

A method for adapting information content of an electronic document onto the electronic device display, the design of the information content of the document being arranged for presentation on a larger display. The electronic document is downloaded into the memory and the network address of the document is compared with the network address of a preceding document. If the domain address of the downloaded document differs from the domain address of the preceding document, the downloaded document is shown miniaturized on the display of the device. If the domain addresses are the same, the information content of said document is compared with the information content of any one document defined as the reference document. If there is a change in the information content that exceeds the predetermined limit value, the downloaded electronic document is presented on the display such that the change will be updated on the display.

### FIELD OF THE INVENTION

The invention relates to devices provided with displays and, in particular, to updating large information content onto a substantially smaller display of the device.

### BACKGROUND OF THE INVENTION

The number of operations to be performed with wireless terminal equipment, such as a mobile station, has increased considerably as a result of the development in mobile technology. The mobile station is no longer used for calls alone, but information can be processed and presented by means of the mobile station in more and more versatile manners. One of the most wanted features of the wireless terminal equipment is a possibility to use Internet services, such as e-mail and graphic web pages. Many other small, portable terminal devices (so-called PDA devices) also comprise means, for instance a WLAN card or a wired connection, for establishing a connection to the Internet.

The layout and usability of almost all graphical services on the Internet are optimised in view of the large display of a desktop computer. Even though a plurality of wireless terminal equipment, such as a plurality of mobile stations, comprise means for establishing an Internet connection, the typically small size of the wireless terminal equipment causes problems, particularly when graphical services are used. Known resolutions of mobile station displays include, for instance, 128×128/160 and 176×208 pixels, whereas web pages are adapted to displays having the resolution of e.g. 800×600, 1024×768 or up to 1280×960 pixels. Consequently, only a small part of the web page can be presented at a time on the display of the wireless terminal equipment and the user gets very little information in one go.

For some mobile stations, such as those using Nokia® Series 60 platform, there are browser programs (e.g. Web Viewer™ and Series 60 platform-specific browser) available, which are able to adapt the content of a web page onto a small display of the mobile station such that the line width of the web page (800, 1024 or 1280 pixels, for instance) are adjusted for a plurality of lines (176 pixels) on the mobile station display and the elements that exceed the display width, such as image files, are scaled into the display width. Thus, the page need not be scrolled in the horizontal direction, but in the vertical direction the page becomes easily very long and it is cumbersome to scroll it.

In addition, the typical web page design causes problems in connection with the above-described procedure. Typically, the web pages are designed such that the title and the control data of the pages appear on the top lines of the page and the so-called navigation bar is located on the left or on the top of the page. Thus, when the content of a web page is arranged onto a small display of the mobile station in the above-described manner by distributing the line width of the web page over a plurality of lines of the mobile station display, these typically unchanged data on each page, i.e. the title and control data and the keys on the navigation bar, are always shown first on the display. For instance, if the user selects a link on the navigation bar, the web page from behind that link is updated to the mobile station, but the user will first see on the display the same unchanged data as before the link selection. In that case the user cannot know, whether the desired web page is updated on the display but he or she must scroll the page downwards to find this out. Moreover, the user cannot know, at which point of the page the new content is updated, but he or she is compelled to scroll the display to find the information and nevertheless may overlook the updated information content.

One solution presented to these problems is a procedure (e.g. Microsoft® SmartView), which presents a page-width-adapted miniature view of the whole Web page, from which miniature view the user may select some areas for viewing. Then, the selected area of the page is presented on the display suitably zoomed.

However, this procedure has several drawbacks, particularly if it is applied to wireless terminal equipment with a small display every time a new page is downloaded. The miniature view of the web page adapted to a small display is so small that it is difficult to distinguish therefrom any detail the user might like to watch closer in enlargement. In addition, it takes a considerable amount of processing power to scale web pages as image files, and thus the continuous, alternating scaling of pages causes considerable loading to current wireless terminal equipment having limited processing power. If the scaling is performed on a network server, extra data transmission between the equipment and the server is produced. Further, this procedure is not feasible in terms of usability, because every time a new page is downloaded, the user is expected to carry out a large number of operations so as to browse the pages.

### BRIEF DESCRIPTION OF THE INVENTION

Now there is invented a method and equipment implementing the method, by which it is possible to improve the visual perspicuity of how information content is updated on small displays. Various aspects of the invention include a method, an electronic device and a computer program, which are characterized by what is stated in the independent claims. Various embodiments of the invention are disclosed in the dependent claims.

The invention is based on the idea that information content comprised by an electronic document, the design of the information content being typically arranged for presentation on a larger display than the one concerned, is arranged on the display of an electronic device by starting to load said electronic document in a memory of the electronic device and by comparing the network address of said electronic document with the network address of a previous electronic document presented on the display of said electronic device. If the domain address of said electronic document differs from the domain address of said previous electronic document, the downloaded document is presented on the display as a miniature view.

If the electronic document to be downloaded and said preceding electronic document are within the same domain address, then, according to an embodiment of the invention, the information content of said electronic document to be downloaded is compared with the information content of an electronic document that is defined as a reference document, and if the information content of said electronic document differs from the information content of said reference document to exceed a defined limit value, said downloaded electronic document is presented on the display of the electronic device such that the first area whose information content differs more than said limit value is updated on the display.

An alternative embodiment is a method for arranging information content comprised by an electronic document onto the display of an electronic device, the design of the information content comprised by the electronic document being arranged for presentation on a larger display than the display of said electronic device. In this method an external server receives a loading request from an electronic device for transmitting an electronic document to the electronic device and compares the network address of said electronic document with the network address of the preceding electronic document presented on the display of said electronic device. If the domain address of the electronic document to be downloaded differs from the domain address of said preceding electronic document, a miniature view is formed from the electronic document defined in said loading request and said miniature view is sent to the electronic device for presentation on its display.

According to one embodiment of the invention the information content of said electronic document is compared with the information content of an electronic document, defined as a reference document, comprised by the cache memory of the browser program of the electronic device or of the server.

According to one embodiment of the invention an electronic document locating in a cache memory and shown as preceding document on the display of an electronic device is defined as a reference document.

According to one embodiment of the invention information contents of said electronic document and said reference document are compared on the basis of a markup-language source code of the documents.

According to one embodiment the comparison takes into account markup-language text element fields of the documents and image elements whose sizes exceed a determined limit value.

According to one embodiment of the invention, in response to a command from the user of the terminal equipment a next area in said electronic document to be downloaded where the information content exceeds said limit value is updated onto the display of the electronic device.

According to one embodiment of the invention, if said electronic document and said reference document have the same domain address, said electronic document to be downloaded is presented on the display of the electronic device from the very beginning in response to at least any one of the following conditions:
the information content of said electronic document does not differ from the information content of said reference document to exceed a predetermined limit value; or
in a cache memory there is no document defined as a reference document.

The method and the device of the invention have an advantage that they allow in particular the user of a device having a small display to find the desired information content in the documents in an illustrative and fast manner. A further advantage is that as conversion of the document into an image file is only performed when the domain address of the downloaded page differs from the domain address of a previous document, the need for conversions is considerably reduced. Another further advantage is that the usability of the device improves, because the mandatory interaction between the user and the device is reduced, because the miniature view is not presented every time. An advantage with one embodiment of the invention is that as the display is automatically updated to show on the display information that is new over the reference document, the need for scrolling the display reduces and the user can immediately study the updated information. Yet another advantage is that the procedure provides the user with an immediate intuitive response, whether the loading of the desired page to the terminal equipment was successful. An alternative embodiment of the invention has an advantage that the comparison between the domain addresses can be carried out on a network server already, whereby the network server can also form a miniature view and transmit it to the terminal equipment, which saves the resources of the terminal equipment.

### BRIEF DESCRIPTION OF THE DRAWINGS

In the following the invention will be described in greater detail in connection with preferred embodiments, with reference to the attached drawings, in which

FIG. 1 is a block diagram of an electronic device, to which the invention can be applied;

FIGS. 2a and 2b illustrate a web page designed for a high display resolution and correspondingly a portion of the page that can be presented at a time on a substantially smaller display; and

FIG. 3 is a flow chart of a procedure of a preferred embodiment of the invention for updating a page automatically on the display.

### DETAILED DESCRIPTION OF THE INVENTION

In the following the invention will be described in greater detail using a portable electronic device with a small display as an illustrative example. The same inventive idea can be applied, however, to any presentation solution of electronic documents, in which the document to be presented is not applicable as such to be presented on the display used. Thus, the described electronic device and the display operationally connected thereto should be understood in broad terms, which cover all presentation solutions of this kind.

FIG. 1 shows a general block diagram of a portable electronic device (ED), which may be a wireless mobile station or a PDA (Personal Digital Assistant) device, for instance, and to which the invention can be applied.

The electronic device (ED) comprises a central unit (CPU), a memory (MEM) and an I/O system (I/O). All the necessary data is stored in the memory (MEM) of the device. The memory (MEM) includes a read memory portion, which may be ROM memory, for instance, and a write memory portion, which may consist of RAM (Random Access Memory) and/or FLASH memory. Through the I/O system (I/O) the device communicates with other devices, the network and the user, among other things. The user interface (UI), which is part of the I/O system (I/O), comprises a necessary interface for communication with the user, such as a display, a keypad, a loudspeaker and/or a microphone. Data obtained from the various components of the device are conveyed to the central unit (CPU), which processes the received data in a desired manner. The display can be integrated with said electronic device or it can be a separate display, which is operationally connected to said electronic device through either a wired connection or a wireless connection.

Intelligent wireless terminal equipment generally employ a platform, on which it is possible to create equipment software and which enables a variety of mobile applications and services. The platform typically comprises a graphical user interface, and applications and technologies built, for instance, on the Symbian operating system, such as multimedia messaging service (MMS), XHTML (Extensible Hypertext Markup Language) browsing and Java. The platform enables the software developers, the operators and the device manufacturers to create advantageously thereon applications of their own, which are compatible with different devices and networks.

One commonly used platform for mobile stations is Nokia® Series 60 Platform, which many other manufacturers of mobile stations have also adopted for use. The display size used on the Series 60 Platform is defined to be 176×208 pixels.

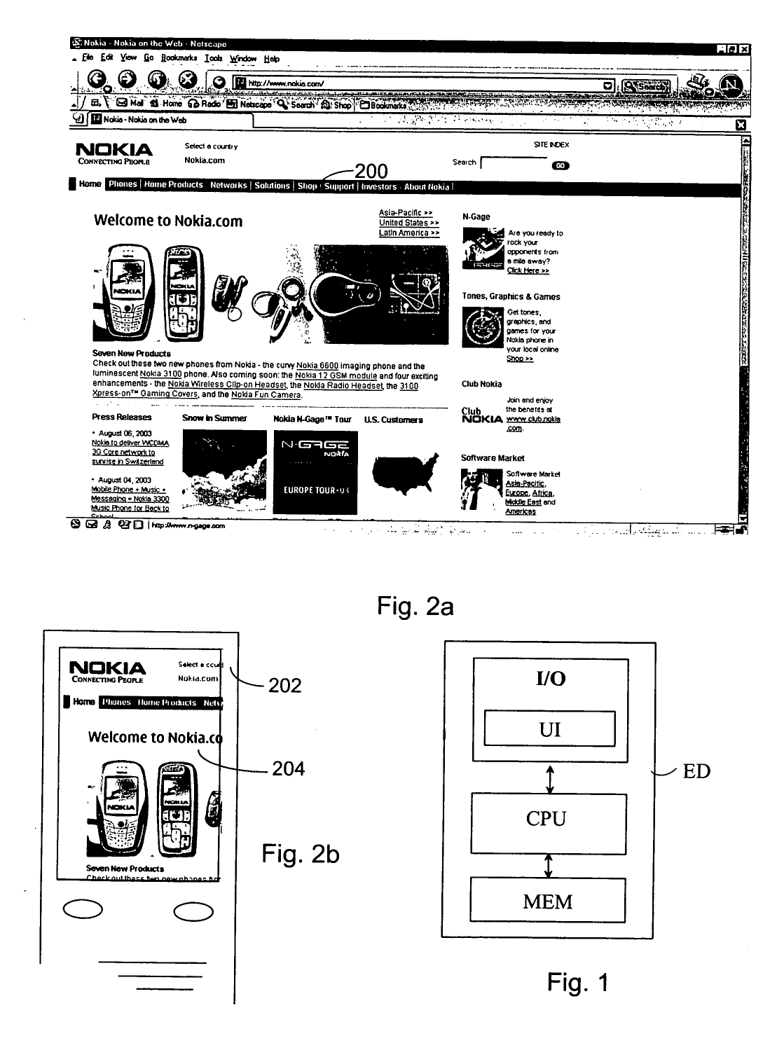

FIGS. 2a and 2b illustrate how limited this display is when information content arranged for a large display is presented. FIG. 2a shows a web page designed for a display resolution of 800×600 pixels. FIG. 2b substantially shows the page portion which can be presented at a time with a display resolution of 176×208 pixels. Thus, FIG. 2b does not show how the page of FIG. 2a would actually be downloaded on said display of 176×208 pixels, because the presentation mode is application-specific. The page can be presented in its original form without any optimisation modifications, as in FIG. 2b, or the page can be optimised, for instance, in the above-described manner by distributing the page width onto a plurality of lines on the display of the mobile station. In page optimisation, the navigation bar 200 on the top of FIG. 2a would typically be shown completely on the display of 176×208 pixels, which further reduces the space available for presenting other information of the page at a time and increases the need for page scrolling, and thus makes it more difficult to find the desired information. Likewise, apart from the navigation bar, only a small part of the web page updated from behind the link is visible, and consequently the user cannot know where on the page the new desired content is updated.

To solve this problem, a procedure has been developed to find desired information content in the documents, which cannot be presented in their original size on the display. The procedure can also be applied in a situation, where the document is zoomed to an extent that it is too big to be presented in its entirety on the display. In the procedure of the invention the network address of a document to be downloaded into the browser program of the terminal equipment is first compared with the network address of the preceding document used by the browser program. So, if the domain address of the page to be downloaded differs from the domain address of said preceding document, the document to be downloaded is presented as a miniature view on the display of the equipment. The term “domain” refers to a group of computers whose host names are within the common domain name. The document to be downloaded can also be retrieved from the device's own file system, in which case the directory path of the file system corresponds to the network address.

If the electronic document to be downloaded and said preceding electronic document are within the same domain name, the page to be downloaded is updated on the display of the wireless terminal equipment such that in case the information contents of the downloaded page of the browser program and of a previous, typically the preceding, page selected as a reference document differ sufficiently from one another, the page to be downloaded is updated on the display automatically such that the first area whose information content has changed sufficiently will be shown on the display. Advantageously this automatic focusing of the information content does not require any operations on the part of the user. Automatic focusing can be performed either by updating a new page from the very beginning and scrolling thereafter the display to said first area where the information content is sufficiently changed or by updating said first area where the information content is sufficiently changed directly onto the display.

It should be noted that the document comparison can be performed either when the document to be downloaded is fully downloaded in the memory of the device, or alternatively, the comparison can be started in the course of the loading by making the comparison at the same pace as a new document is being loaded in the memory of the device. The last mentioned manner speeds up the automatic focusing of the information content, in particular in wireless terminal equipments, because for larger documents loading delays on wireless connections may be quite considerable. The last mentioned manner is also advantageously applicable to known browser programs of wireless devices, which programs typically start updating of a page on a display even before the page is fully downloaded.

In order that the document downloaded in the browser program could be presented as a scalable document it is typically to be converted to an image file, which requires considerable processing resources of the converting device. Because the conversion is only performed when the domain address of the downloaded page differs from the domain address of the preceding page, the need for conversion reduces considerably, the major part of the web page browsing typically taking place within the same domain addresses.

The user may select from the miniature view presented on the display a desired area for a closer look, whereby this area is presented sufficiently zoomed on the display and the original lines optionally distributed into a plurality of narrower lines. Because it may be difficult to distinguish the changed information content in the miniature view, it can be highlighted on the display, for instance using a text or a background of different colour. Thus, instead of automatic focusing, the user is first shown only the area, where the first change in the document is found.

The above-described procedure for finding the desired information content in the documents allow the user of a device with a small display to find information in an illustrative and fast manner. On moving over to a totally new document (new domain address) the user is provided with a general view in a miniature format of the document, whereby the user can quickly visualise the structure and the information content of the document on a general level. When the user then selects from this miniature view, for instance, a hyperlink of a view that opened through the area selected from the miniature view, the miniature is no longer used but the above-described automatic focusing to the area to be viewed will take place.

According to the preferred embodiment of the invention, by activating a given function with a click of a mouse or some other indicator, the user may update the page on the display automatically such that a next area with sufficiently changed information content is shown on the display. Thus, the user is able to go through quickly the changed areas of the page or the document.

According to the preferred embodiment of the invention, in particular the comparison between the web page information contents is performed between the information content of the downloaded page and that of the preceding page in the cache memory of the browser program. Thus, the changes, if any, in visual layout of the pages are omitted from the comparison. This has a particular advantage in the above-described solution, in which the content of a normal-size web page is adjusted onto a small display of a mobile station such that the line width of the web page is arranged onto a plurality of lines on the mobile station display. Naturally, it will be necessary to modify the page layout settings, but advantageously it does not affect the comparison according to the invention.

According to one preferred embodiment of the invention, the reference document need not necessarily be the preceding browsed page, but the comparison can be made with a given basic page or document, which is advantageously defined in accordance with the page or directory structure. For instance, when moving over from document a://aaa/aaa.html” to document “a://aaa/bbb.html” the reference item used will be the basic document “a://index.html”. Owing to the page or directory structure, comparison of this kind may in some cases be more advantageous to illustrate the differences between the documents.

According to one preferred embodiment of the invention, the comparison is based on the markup language source code of the pages and the comparison is performed between the contents of given elements thereof. Typically, the web pages are defined as HTML (HyperText Markup Language) source code, which comprises element definitions for all text and image fields appearing on the pages as well as for various layouts thereof. The comparison takes into account at least all text element fields and image elements outputted on the display. It should be noted that the procedure of the invention is not restricted only to the HTML documents but it can be applied to any structural documents whose metadata enables comparison between document contents. These documents include, for instance, XML (Extensible Markup Language) and XHTML (Extensible Hypertext Markup Language) files as well as Microsoft® Word and Adobe® PDF documents. So-called rich text and plain text documents can also be compared with one another in the above-described manner, which makes it possible to find recent changes in bus or train timetables, for instance. Thus, the term “browser program” should also be interpreted in a broad sense to include, in addition to conventional web browser programs, such as web browsers presenting HTML-based Internet pages, also application programs presenting structural documents, such as a plurality of word processing programs.

According to one preferred embodiment of the invention, the comparison can be performed either in the terminal equipment or on the download server of the network or both. For instance, the Web Viewer™ browser which adapts the content of a normal-sized web page in the above-described manner onto the small display of a mobile station by distributing the line width of the web page over a plurality of lines on the display of the mobile station, utilizes the optimisation server locating in the network, which converts the web page into a layout that is suitable for a narrow display and thus speeds up the downloading of the page. Advantageously the optimisation server is also aware of the previous web page downloaded by the terminal equipment and the source code thereof. Hence, the above-described comparison can be performed already on said optimisation server and the new page can be provided with an indication where in the document the first sufficiently changed information content is found. The terminal equipment can utilize this indication for updating the changed information content on the display.

According to one preferred embodiment of the invention, the server transmits to the terminal equipment only the information that has changed with respect to the preceding page, in response to which the browser program uses the preceding page as a base and updates the changed portions thereon. Advantageously this reduces the network load, because the amount of data to be transmitted over the network is often substantially smaller than in transmitting the whole page. Information on the changed information content can be transmitted using “document fragment identifier” indicators of HTML version 4.01, for instance, whereby the procedure of the invention can be applied by means of the server also to those old browser programs, for instance, that do not support the method themselves.

According to one preferred embodiment of the invention, the terminal equipment comprises user-controllable settings, by means of which the above-described document presentation formats can be controlled. The settings may comprise a function, according to which a miniature view is not shown at any stage, but an automatic transfer always takes place to the document area where the first sufficiently changed content can be found. Correspondingly, said settings may control the terminal equipment to always show a miniature view of the page first. Further, an alternative may be to show a miniature view of the first page of a given domain address group and the rest of the pages in the same domain address group are shown by automatically zooming to the changed content. The setting may also control the terminal equipment to show the documents always as such, in other words, showing the miniature view or zooming to the changed content will not be performed at any stage.

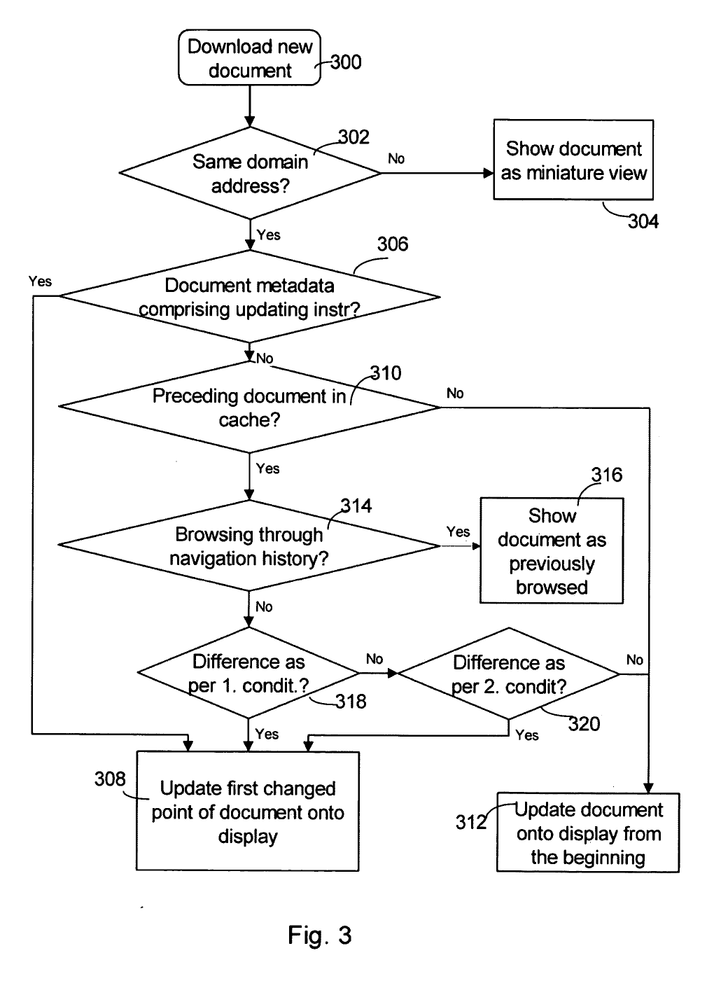

The procedure of the invention for finding the desired information content will be illustrated in the following by way of example, with reference to the flow chart of FIG. 3. In the example of FIG. 3 the first step (comparison of domain addresses) can be performed either in the terminal equipment or on the download server of the network and the subsequent steps will advantageously be performed in the terminal equipment. In addition, FIG. 3 shows only one example of a comparison algorithm and comparison criteria used therein. It is obvious to a person skilled in the art that the same inventive idea can be implemented with a variety of comparison algorithms and comparison criteria.

The starting point of the procedure shown in FIG. 3 is a function performed by the user of the terminal equipment in the browser program for downloading a new page to be presented with the browser program (300). The function performed by the user may consist, for instance, of activating a hyperlink on the preceding page (e.g. by clicking the link with an indicator) or of writing the URL address of a new page in the address field of the browser program.

Downloading a new page starts the comparison algorithm, which is performed either prior to showing the new page on the display (or transmitting it to the terminal equipment if the comparison takes place on the network server), or, alternatively, in the above-described manner in the course of downloading by comparing at the same pace as the new document is loaded in the memory of the equipment. The first step (302) in the comparison algorithm is to check whether the network address of the page to be downloaded includes the same domain address as the network address of the preceding page shown in the browser program of the terminal device. If the network addresses do not include the same domain address or the preceding page was not used, the page is formatted into a miniature view, which is shown on the display (304) of the terminal equipment.

If the network address of the page to be downloaded includes the same domain address as the network address of the preceding page shown in the browser program of the terminal device, it is checked next (306), whether the metadata of the page to be downloaded comprises instructions to update the page on the display. It is possible that the page comparison was performed in the above-mentioned manner on the optimisation server, which either added an indication of changed information content to the new page or only transmitted the changed information content without any other data comprised by the page. In that case, the browser program updates the new page on the display according to the updating instructions such that the page area where said changed information content is located will be updated substantially on the top of the display of the terminal equipment (308).

If the metadata of the document does not comprise updating instructions, the process proceeds to the next step (310) of the comparison algorithm where it is checked, whether the preceding page was stored in the cache memory of the browser program. If the preceding page is not in the cache memory, no comparison between a new page and the preceding page can be performed, and consequently the new page is shown on the display such that its beginning is visible on the display (312) and the rest of the page will appear by scrolling the display down.

If the preceding page was stored in the cache memory, it is checked next, whether the transfer to the new page was performed by means of the navigation history of the browser program (314), i.e. whether the new page is one of the preceding pages of the same session, whereby the transfer can take place by means of “back/forward” commands of the browser program, for instance. If the navigation history is employed in the browsing, the comparison between the pages is not carried out but the page is downloaded from the point where the browsing previously ended (316).

The page to be downloaded may comprise a definition which prevents the page from being permanently stored in the cache memory of the browser program, and thus when the page is exited, said page will no longer be found in the cache memory. This problem can be circumvented, however, by storing said pages in the cache memory for comparison such that every time said page is re-entered, the page is downloaded again from the web. For instance, some web pages employ so-called scripts (e.g. Java/ECMAScript) for generating information contents. In that case the preceding page should be processed in the comparison in the format it would be after executing the scripts. The comparison could be advantageously enhanced by storing the page, instead of or in addition to the original source code, in a format optimised for comparison.

If the domain address of the new page and the preceding page is the same, comparison between the information contents of the pages is performed in relation to the first set comparison criteria (318). The first comparison criteria are advantageously set such that the contents of the pages should be sufficiently different so as to have an effect on the updating of the new page on the display. Advantageously the comparison is performed on the basis of the markup language, such as HTML, source code, whereby contents of given elements between the pages are compared. The comparison is advantageously directed only to the information contents of the pages, and thus changes in visual layout of the pages, for instance, will be omitted from the comparison. The premise is that changes in the textual content and in sufficiently large image files will be taken into account, for instance.

In the first comparison a criterion for sufficient difference can be, for instance, that the new page comprises at least an eight-word sequence that differs from the preceding page stored in the cache memory. Each new image file differing from the preceding page can be counted as four new words, for instance. In that case it is also possible to set a restriction that images smaller than 30×30 pixels, for instance, will be omitted, because they are typically associated with the layout and presentation of the page and they do not affect the information content of the page. Correspondingly, a sufficiently large image file can be interpreted as eight words, whereby it alone can be interpreted as a sufficiently great change. For instance, when HTML source codes are compared, all text element fields and textual hyperlinks (<a>) and all image elements (<img>), selection elements (<select>) and object elements (<object>) outputted on the display will be taken into account, in view of the above-mentioned 30×30 pixel restriction. If it is detected in the first comparison (318) that there is a sufficient difference in the first criteria, a new page is updated on the display such that a first area of the new page where said sufficient difference have been detected, will be updated substantially on the top of the display (308). Thus the downloaded page is updated automatically on the display in such a manner that the first sufficiently changed area is brought in the foreground, whereby the user will immediately notice the difference from the preceding page. Naturally the user can scroll the page in any direction from the area updated on the display.

If the first comparison does not detect a sufficient difference between the pages, for instance, eight consecutive words, according to the first criteria, a second comparison can advantageously be performed according to second criteria set for comparison (320). In this comparison any change in the information content, such as one new image, can be interpreted as a sufficiently great change, whereby the page is automatically zoomed to that area (308). If the second comparison does not find any change between the pages, a new page is shown such that the beginning thereof is substantially at the top of the display (312).

According to one preferred embodiment of the invention, in addition to the algorithm based on examining the document source code, the search for an area with changed information content can also be implemented by utilizing pattern recognition, whereby the information content of images, for instance, can be taken better into account in the comparison, and the definition of differences in the images does not only rely on the comparison between the titles and the sizes of the image files.

In portable terminal equipment, such as a mobile station, the functionality of the invention can be implemented most advantageously as browser application software, which is executed in the central processing unit CPU and makes the terminal equipment carry out operations according to the invention. Most advantageously the computer program can be implemented as a plug-in program loaded in the terminal equipment or in connection with the browser program. Functions of the software SW can be distributed to a plurality of separate, intercommunicating software components. The computer program can be stored in any memory means, for instance, on a PC hard disk or a CD-ROM, from which it can be loaded in the memory MEM of the mobile station MS. The computer program can also be downloaded through the network by using a TCP/IP protocol stack, for instance. It is also possible to use hardware solutions or a combination of hardware and software solutions to implement the inventive means.

Thus, the computer program SW advantageously comprises a computer program code section for comparing the network address of said electronic document with the network address of the preceding electronic document shown on the display of said electronic device and a computer program code section for showing said downloaded electronic document on the display as a miniature view in response to the domain address of said downloaded electronic document differing from the domain address of said preceding electronic document.

In addition, the computer program SW may advantageously comprise a computer program code section for comparing the information content of said electronic document with the information content of the preceding electronic document shown on the display of said electronic device and a computer program code section for showing said downloaded electronic document on the display such that a first area of said downloaded electronic document that differs from the information content of said preceding electronic document to exceed a predetermined limit value will be updated on the display.

In addition, most advantageously the above-described features of the optimisation server in accordance with the invention can be implemented as a computer program. In that case the computer program advantageously comprises a computer program code section for receiving a download request, made by an electronic device, for transmitting an electronic document to the electronic device, a computer program section for comparing the domain address of said electronic document defined in the download request with the domain address of the preceding electronic document transmitted to the electronic device and a computer program code section for modifying said electronic document into a miniature view and for transmitting it to the electronic device for presentation on the display.

It is obvious to a person skilled in the art that as technology advances the basic ideas of the invention can be implemented in a variety of ways. Thus, the invention and its embodiments are not restricted to the above-described examples, but they may vary within the scope of the claims.

1. A method for arranging information content comprised by an electronic document on the display of an electronic device, the design of the information content of the electronic document being arranged for presentation on a larger display than the display of said electronic device, the method comprising:
starting to download said electronic document in a memory of the electronic device;
comparing the network address of said electronic document with the network address of a previous electronic document presented on the display of said electronic device; and
in response to the network address of said electronic document to be loaded differing from the network address of said previous electronic document,
presenting said electronic document to be loaded in a miniaturized format on the display of the electronic device.

2. A method for arranging information content comprised by an electronic document on the display of an electronic device, the design of the information content being arranged for presentation on a larger display than the display of said electronic device, the method comprising:
receiving on an external server a download request made by the electronic device for transmitting the electronic document to the electronic device;
comparing the network address of said electronic document with the network address of the preceding electronic document shown on the display of said electronic device;
in response to the network address of said electronic document to be downloaded differing from the network address of said preceding electronic document,
forming a miniature view of said electronic document defined in the download request; and
transmitting said miniature view to the electronic device for presentation on its display.

3. A method as claimed in claim 1, wherein said network address is the domain address or a directory path address of the document.

4. A method as claimed in claim 1, further comprising
in response to the network address of said electronic document and the network address of said previous electronic document comprising the same domain address,
comparing in said electronic device the information content of the electronic document with the information content of an electronic document defined as a reference document; and
in response to the information content of said electronic document to be downloaded differing from the information content of said reference document to exceed a predetermined limit value,
presenting said electronic document to be downloaded on the display of the electronic device such that a first area where difference in information content exceeds said limit value will be updated on the display.

5. A method as claimed in claim 3, further comprising
comparing the information content of said electronic document with the information content of the electronic document defined as the reference document comprised by the cache memory of the server or of the browser program of the electronic device.

6. A method as claimed in claim in claim 4, further comprising
defining as the reference document the preceding electronic document locating in the cache memory and shown on the display of the electronic device.

7. A method as claimed in claim 6, further comprising
considering in the comparison the definition language text element fields and image elements whose size exceeds a predetermined limit value in the documents.

8. A method as claimed in claim 3, further comprising
comparing the information contents of said electronic document and said reference document on the basis of the markup language source code of the documents.

9. A method as claimed in claim 3, further comprising
in response to a command from the user of the terminal equipment,
updating on the display of the electronic device a next area in said electronic document to be downloaded where difference in the information content exceeds said limit value.

10. A method as claimed in claim 3, further comprising
presenting said electronic document to be downloaded on the display of the electronic device from the beginning in response to any one of the following conditions:
the information content of said electronic document does not differ from the information content of said reference document to exceed the predetermined limit value; or
in the cache memory, there is no document defined as the reference document.

11. An electronic device comprising
a display in operational connection with the device;
a browser program for adapting the information content of the electronic document onto said display;
means for loading said electronic document into the memory;
means for comparing the network address of said electronic document with the network address of a previous electronic document shown on the display of said electronic device; and
means for presenting said electronic document to be downloaded as a miniature view in response to the network address of said electronic document to be downloaded differing from the network address of said previous electronic document.

12. An electronic device as claimed in claim 11, further comprising
means for comparing the information content of said electronic document with the information content of any one electronic document defined as the reference document, and
means for presenting said electronic document to be downloaded on the display such that a first area of said electronic document to be downloaded where the difference in the information content exceeds the predetermined limit value will be updated on the display.

13. An electronic device as claimed in claim 11, wherein
said network address is the domain address or a directory path address of the document.

14. An electronic device as claimed in claim 12, wherein
said means for comparing the information content is arranged to compare the information content of said electronic document with the information content of the electronic document defined as the reference document comprised by the cache memory of the server or of the browser program of the electronic device.

15. An electronic device as claimed in claim 12, wherein
said reference document is a preceding electronic document locating in the cache memory and shown on the display of the electronic device.

16. An electronic device as claimed in claim 14, wherein
said means for comparing the information content is arranged to compare the information contents of said electronic document and said reference document on the basis of the markup language source code of the documents.

17. An electronic device as claimed in claim 16, wherein
said means for comparing the information content is arranged to consider in the comparison the definition language text element fields and image elements whose size exceeds a predetermined limit value in the documents.

18. An electronic device as claimed in claim 14, wherein
said means for presenting said electronic document is arranged, in response to a command from the user of the terminal equipment, to update on the display of the electronic device a next area in said electronic document to be downloaded where difference in the information content exceeds said limit value.

19. An electronic device as claimed in claim 14, wherein
said means for presenting said electronic document is arranged to present said electronic document to be downloaded on the display of the electronic device from the beginning in response to any one of the following conditions:
the information content of said electronic document does not differ from the information content of said reference document to exceed the predetermined limit value; or
in the cache memory, there is no document defined as the reference document.

20. A software product, which, loaded in an electronic device, is arranged to control the adaptation of the information content of an electronic document to be loaded in the memory of the electronic device onto the display of the electronic device, the software product comprising
a computer program code section for comparing the network address of said electronic document with the network address of a previous electronic document shown on the display of said electronic device; and
a computer program code section for showing said electronic document to be downloaded on the display as a miniature view in response to the network address of said electronic document to be downloaded differing from the network address of said previous electronic document.

21. A software product as claimed in claim 20, further comprising
a computer program code section for comparing the information content of said electronic document with the information content of any one electronic document defined as the reference document; and
a computer program code section for presenting said electronic document to be downloaded on the display such that a first area of the electronic document where the difference in the information content exceeds the predetermined limit value will be updated on the display.

22. A software product as claimed in claim 21, wherein
said computer program code section for comparing the information content is arranged to compare the information content of said electronic document with the information content of the electronic document defined as the reference document comprised by the cache memory of the server or of the browser program of the electronic device.

23. A software product as claimed in claim 22, wherein
said computer program code section for comparing the information content further includes a computer program code section for comparing the information contents of said electronic document and said reference document on the basis of the markup language source code of the documents.

24. A software product as claimed in claim 23, wherein
said computer program code section for comparing the information content further includes a computer program code section for considering in the comparison the definition language text element fields and image elements whose size exceeds a predetermined limit value in the documents.

25. A software product as claimed in claim 21, wherein
said computer program code section for presenting said electronic document is arranged to control the electronic device to present said electronic document to be downloaded on the display of the electronic device from the beginning in response to any one of the following conditions:
the information content of said electronic document does not differ from the information content of said reference document to exceed the predetermined limit value; or
in the cache memory, there is no document defined as the reference document.

26. A network element arranged to fitting information content comprised by an electronic document onto the display of an electronic device, formatting of the information content of the electronic document being adapted to be shown on a display larger than that of said electronic device; the network element comprising
means for receiving a downloading request presented by the electronic device for transmitting an electronic document to the device;
means for comparing the network address of said electronic document with the network address of the preceding electronic document shown on the display of said electronic device;
means for forming a miniature view of said electronic document defined in the download request, if the network address of said electronic document to be downloaded differs from the network address of said preceding electronic document; and
means for transmitting said miniature view to the electronic device for presentation on its display.
